(19) United States
(12) Patent Application Publication
(10) Pub. No.: US 2016/0262426 A1
(43) Pub. Date: Sep. 15, 2016

(54) HIGH PROTEIN DISTILLERS DRIED GRAINS WITH SOLUBLES AND METHODS THEREOF

(71) Applicant: Novita Nutrition, LLC, Brookings, SD (US)

(72) Inventors: Keith Bruinsma, Brookings, SD (US); Donald Endres, Brookings, SD (US); Steven J. Furcich, Monticello, IL (US)

(21) Appl. No.: 15/066,525

(22) Filed: Mar. 10, 2016

Related U.S. Application Data
(60) Provisional application No. 62/132,925, filed on Mar. 13, 2015.

(51) Int. Cl. A23K 1/06

(52) U.S. Cl. CPC A23K 1/06

(57) ABSTRACT

Distillers dried grain with solubles (DDGS), such as DDGS from an ethanol process, can undergo a denaturing process resulting in higher measurable protein content. The denatured DDGS byproduct, which may include higher measurable rumen undegradable protein products or bypass proteins, can be used to produce distillers meal, which may be used as an animal feed and are able to survive the digestive process through the rumen of ruminant animals that results in more protein bioavaible to the ruminant animal in the later stages of digestion and absorption. The DDGS co-product can undergo a denaturing process to produce distillers meal having an increased rumen undegradable protein level that is about 5% to about 25% more than a rumen undegradable protein level of the distillers meal prior to the denatuting process of the DDGS co-product. Such high protein content compositions can also be used in methods for increasing nitrogen content in soil, promoting crop production, and fertilizing horticultural and/or agricultural crops.

### CROSS-REFERENCE TO RELATED APPLICATION

The present application claims the benefit of U.S. Provisional Application No. 62/132,925, filed Mar. 13, 2015, which is hereby incorporated herein in its entirety by reference.

### TECHNICAL FIELD

The present invention relates generally to the desolventization of distillers dried grain solubles (DDGS) to produce high protein content compositions. More particularly, the present invention relates to DDGS co-product from an ethanol process that have undergone a denaturing process resulting in higher measurable rumen undegradable protein products or bypass proteins derived from the DDGS byproduct, which are able to survive the digestive process through the rumen of ruminant animals that results in more protein bioavaible to the ruminant animal in the later stages of digestion and absorption. The present invention also relates generally to such high protein content compositions used in methods for increasing nitrogen content in soil, promoting crop production, and fertilizing horticultural and/or agricultural crops.

### BACKGROUND

Ethanol can be produced using grains, such as corn, which are renewable resources. Presently, the majority of ethanol-producing biorefineries in the United States are dry-grind corn biorefineries, and it is estimated that the present ethanol production capacity of such biorefineries runs into the billions of gallons each year. Co-products of the ethanol biorefining process are distillers dried grains (DDG) and distillers dried grains with solubles (DDGS). Based on current production rates of ethanol from dry-grind ethanol plants, approximately over 40 million tons of DDGS are produced in the United States annually.

Over the past few decades, achieving an ethanol product from grain-based biorefineries that is both commercial viable and truly renewable has proven challenging. Two of the more significant hurdles are: 1) the cost of grain-based ethanol production; and 2) the energy input to output ratio of grain-based ethanol production processes. As is easily appreciated, these two problems are intertwined. Grain-based ethanol production has historically required significant and costly input of fossil fuels (e.g., natural gas) to drive the biorefining process. Moreover, the amount of fossil fuel that has been historically required to drive grain-based ethanol production is costly, particularly so as the cost of natural gas and other fossil fuels increases.

One of the ways by which the effective cost of grain-based ethanol production can be reduced is the sale of commercially valuable co-products of the biorefining process. DDGS and/or DDG are co-products of grain-based ethanol production processes that have recognized commercial value. In particular, DDGS are sold as a livestock feed supplement. Because it is primarily the starch of the grain that is consumed in the production of ethanol, the DDGS remaining after fermentation and distillation contain nutritionally valuable fiber, protein and fat. Relative to raw grain, DDGS may even be considered a superior feed, as they contain concentrated amounts of fiber, protein and fat, together with a significantly reduced amount of starch. In addition, DDGS are considerably less expensive than some feeds of comparable nutritional value. Despite the potential benefits of DDGS as a superior feed, the unsaturated fats in normal DDGS products are known to reduce butterfat production in dairy cows, which limits the value of DDGS to dairy producers.

In addition, as provided in U.S. Pat. No. 7,183,237, a significant part of the production cost of grain has been in the control of weeds with herbicides, which can be supplemented/replaced with the use of DDGS as an herbicide and a fertilizer in the use of crop production. However, normal DDGS co-products contain the natural oil content, which makes them more readily susceptible to chemical and microbial degradation in long term storage and when applied to soil.

There is, therefore, a need for DDGS co-products that do not exhibit the disadvantages of known DDGS co-products as animal feed supplements, herbicides and/or fertilizers, but include many or all of the advantages exhibited by these products.

### SUMMARY

The present invention is directed at a process that uses DDGS byproduct as an input material, the process including denaturing the DDGS byproduct to increase the levels of rumen undegradable protein (“RUP”). In some aspects, the levels of RUP are increased at least 5% compared to the input DDGS byproduct. In some aspects, the levels of RUP are increased between about 5% and up to about 25% or more compared to the input DDGS byproduct. In some aspects, the levels of RUP are increased between about 10% up to about 25% compared to the input DDGS byproduct.

In some aspects, the DDGS byproduct undergoes an oil extraction step to result in the levels at or below about 2%, the de-oiled DDGS undergoing a further desolventization step to remove a solvent used during the solvent extraction process, the de-oiled, desolventized DDGS may undergo one or more of a heating or toasting step and drying step followed by a cooling step. In some alternative aspects, the DDGS byproduct may bypass the oil extraction process if the DDGS byproduct input has about 5% oil content or less. In some alternative aspects, the DDGS byproduct may bypass the oil extraction process if the DDGS byproduct input has about 6% oil content or less. In some alternative aspects, the DDGS byproduct may bypass the oil extraction process if the DDGS byproduct input has about 7% oil content or less.

In some aspects, the desolventizing, toasting, drying and cooling processes can be accomplished in a single vessel referred to as a DTDC. In some aspects, the desolventizing and toasting processes are combined in one vessel, referred to as a DT, and the drying and cooling processes are combined in a separate vessel referred to as a DC. In some aspects, the desolventizing and toasting processes are conducted in a Crown® DT and the drying and cooling processes are conducted in a Crown® DC.

In some aspects, in the DDGS desolventizing, toasting, drying and cooling process steps, the solvent used to remove oil from the DDGS byproduct is removed from the de-oiled DDGS material and may be recovered for re-use, the de-oiled DDGS material is heated or toasted, the de-oiled DDGS material is dried to within acceptable moisture requirements, and the de-oiled DDGS material is cooled to near ambient temperature to remain stable and flowable during storage and transport. The resultant desolventized, toasted, dried and cooled DDGS product is commonly referred to herein as corn distillers meal.

In some aspects, steam is injected into the DDGS byproduct during the oil extraction desolventization step, the live steam creating a sparging process. In some aspects, the live steam is applied during desolventization step for at least 20 minutes, in some other aspects at least 25 minutes, more preferably at least 30 minutes, and in some other preferable aspects between about 20 minutes and about 50 minutes. In some aspects, the drum has a lower screen that can be used to facilitate the desolventization process.

In some aspects, the de-oiled, desolventized DDGS undergoes the heating and drying step by applying airflow at a temperature between about 200° F. and about 325° F., more preferably between about 250° F. and about 310° F., more preferably between about 265° F. and about 300° F., and most preferably between about 275° F. and about 290° F., for a period of time between about 30 minutes to about 90 minutes, more preferably between about 40 minutes and about 80 minutes, most preferably between about 45 minutes and about 60 minutes, at a flow rate between about 15 CFM/T to about 75 CFM/T, more preferably between about 20 CFM/T to about 60 CFM/T, more preferably between about 25 CFM/T and about 50 CFM/T, and most preferably between about 25 CFM/T and about 30 CFM/T. In some aspects, the heating and drying steps are conducted in a DC having at least 3 dryer stacks, in some aspects in a DC having at least 4 dryer stacks, and in some other aspects in a DC having at least 5 dryer stacks.

In some aspects, after the heating and drying steps, the de-oiled, desensitized DDGS undergoes a cooling step. In some aspects, the de-oiled, desolventized, heated and dried DDGS is cooled in ambient air at a flow rate between about 25 CFM/T to about 60 CFM/T, more preferably between about 30 CFM/T to about 50 CFM/T, most preferably between about 35 CFM/T and about 45 CFM/T, for a period of time between about 5 minutes to about 30 minutes, more preferably between about 5 minutes and about 20 minutes, and most preferably about 10 minutes.

In some aspects, the desolventizing, toasting, drying and cooling processes can be accomplished in a single vessel referred to as a DTDC. In some aspects, the desolventizing and toasting processes are combined in one vessel, referred to as a DT, and the drying and cooling processes are combined in a separate vessel referred to as a DC. In the DDGS desolventizing, toasting, drying and cooling process path, all but trace amounts of the solvent used to remove oil from the DDGS byproduct is removed from the de-oiled DDGS material and may be recovered for re-use, the de-oiled DDGS material is heated or toasted, the de-oiled DDGS material is dried to within acceptable moisture requirements, and the de-oiled DDGS material is cooled to near ambient temperature to remain stable and flowable during storage and transport. The resultant desolventized, toasted, dried and cooled DDGS product is commonly referred to herein as corn distillers meal.

In some aspects, the total protein content of the resulting DDGS co-product (whether undergoing the de-oiling step or not) has greater than about 60% RUP.

In some aspects, the total protein content of the resulting DDGS co-product has greater than about 55% intestinally absorbable digestible protein.

In some aspects, the DDGS co-product of the present invention contain a high RUP protein component, often referred to as bypass proteins, which are able to survive the rumen of a ruminant animal during the digestive process, such that more protein is bioavailable to the ruminant animal in the later stages of digestion, which results in greater protein absorption. In some aspects, the greater protein absorption occurs in dairy cows, which increase milk production. In some aspects, the levels of RUP in the DDGS co-product are about 5% to about or more compared to the input DDGS byproduct. In some aspects, the levels of RUP in the DDGS co-product are about 10% to about 25% more compared to the input DDGS byproduct.

In some aspects, serum blood urea nitrogen (BUN) values of blood samples taken from dairy cows that have been fed DDGS co-products of the present invention confirm the delivery of more nitrogen to the blood of the animals, which is indicative of increased absorbed protein. Without wishing to be bound by theory, it is contemplated that the increased protein absorption of animals fed DDGS co-products compared to input DDGS is the result of RUP and the late stages of digestion beyond the rumen of the ruminant animal.

In some aspects, the input DDGS undergoes a particle size reduction prior to the solvent extraction process of the present invention. In some aspects, the input :DDGS has a particle size that passes 6 mesh, in some other aspects 10 mesh. In some aspects, the reduction of particle size prior to the solvent extraction process of the present invention results in DDGS co-product having a higher RUP content.

In some aspects, the DDGS co-product of the present invention may be used in soil applications. In some aspects, a dry granular form of the DDGS co-product of the present invention provides extended/sustained release of nitrogen to the soil while slowly biodegrading compared to free nitrogen applications, In some aspects, the DDGS co-product of the present invention include amino acids, peptides and other organic compounds, which may have anti-fungal and/or anti-microbial properties. The DDGS co-products of the present invention may also be used to help support improved microbiological health and desirable microbe populations in the soil.

In some aspects, the slower biodegradation of the DDGS co-product of the present invention provides a sustained release of amino acids, peptides and other organic compounds to the soil during decomposition. The use of such DDGS co-product may produce healthier soils, resulting in higher plant yields, better color turf, and better resistance of the plants to injury and disease.

In some aspects, the DDGS co-products of the present invention may he used in various horticulture and fertilizer applications, including commercial agriculture, turf and landscaping, and ornamental plant applications. In some aspects, the DDGS co-products of the present invention can be used alone, or in some aspects in combination with other agricultural processing by-products.

In some aspects, the DDGS co-products of the present invention can be provided in a dry (native) granular form, micro ground form and/or coated form, which may include hydrophilic gels, slow release agents, colored coatings, other premix additives, and/or be micro encapsulated. In some aspects, the DDGS co-products of the present invention can be in a water dispersible form (with or without emulsifiers and/or dispersing agents and/or surfactants), which are applied by a liquid application. In some aspects, the DDGS co-product of the present invention can be dispersed in water and applied thru a spray nozzle for application to soil.

Other features and advantages of the invention will become more apparent from the following description thereof, given only for illustrative and in no way restrictive purposes, with reference to several embodiments illustrated in the accompanying drawings, in which:

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject nuatter hereof may be more completely understood in consideration of the following detailed description of various embodiments in connection with the accompanying figures, in which:

FIG. 1 provides a flow-chart representation of the process by which crude oil is extracted from DDGS byproduct and the de-oiled DDGS undergoes a further denaturing process resulting in higher measurable nimen undegradable protein products or bypass proteins derived from the DDGS byproduct according to certain aspects of the present invention.

While various embodiments are amenable to various modifications and alternative forms, specifics thereof have been shown by way of example in the drawings and will be described in detail. It should bounders d, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

It will be readily understood that the methods and materials as they are generally described and illustrated in the figures herein could be arranged and designed in a wide variety of different configurations. Thus, the following more detailed description of various embodiments of the methods and materials provided herein is not intended to limit the scope of the claims, but merely provides representative examples of various embodiments of the subject matter recited in the appended claims. For example, though distillers dried grains with solubles (DDGS) are referenced herein with respect to the methods and materials described, it is to be understood that distillers dried grains (DDG) could also be utilized instead of or in addition to the DDGS. In particular, DDG retain significant oil content, and in embodiments of the processes and methods described herein DDG may be used in place of DDGS or in combination with DDGS. Moreover, DDG retain valuable nutrient properties and distillers meal, resulting from solvent extraction of DDG according to the methods described herein, may also be utilized as an animal feed supplement, herbicide and/or fertilizer product. Also, while every ethanol plant is configured differently, each ethanol plants handles recycle streams differently, including recycling different process streams of solubles to the distilled dried grains. Thus, the following description, while specific to DDGS, should also be understood to be applicable to DDG individually, or in combination with DDGS.

As is described herein, the commercial value of the co-products DDG and/or DDGS from grain-based ethanol production processes can be further enhanced. In particular, commercially valuable amounts of oil can be extracted from the DDG and/or DDGS using a solvent extraction process, which can be further processed to provide valuable co-products, such as that disclosed in U.S. Pat. No. 8,227,015, U.S. Patent Application Publication No. 2012/0294977 A1 and U.S. Patent Application Publication No. 2013/021688 A1, the disclosures of which are incorporated by referenced in their entireties. In addition, the DDG and/or DDGS co-products resulting from solvent extraction as described herein is still suitable for use as an animal feed ingredient, such as, for example, an animal feed supplement or constituent for domestic pets, livestock (such as beef cattle, dairy cattle, equine, sheep and/or swine), aquaculture or poultry, including chickens, geese and/or turkey. Therefore, solvent extraction of DDG and DDGS according to the methods described herein may facilitate a reduction in the effective costs of producing ethanol from a grain-based biorefinery, as it allows for production of multiple, commercially-valuable products from DDG and DDGS. For instance, the DDG and/or DDGS that undergo the solvent extraction process of the present invention can provide valuable products, such as animal feed supplements, herbicides and/or fertilizers.

In one embodiment, ethanol production, solvent extraction of DDGS, and refining of the crude oil removed from the DDGS can occur in a single facility. For example, in such an embodiment, a grain-based ethanol biorefinery may further include facilities for solvent extraction of the DDGS produced at the biorefinery. In another such embodiment, a grain-based ethanol biorefinery may further include facilities for solvent extraction of the DDGS produced at the biorefinery and facilities for processing the crude oil extracted from the DDGS to provide food-grade oil suitable for consumer use. In yet another embodiment, a grain-based ethanol biorefinery may further include facilities for solvent extraction of the DDGS produced at the biorefinery and facilities for processing the DDGS that undergoes the solvent extraction process of the present invention. By integrating these operations within a single facility, process efficiencies may be gained and costs of solvent extracting the DDGS and processing or refining the extracted oil may be reduced.

In some aspects, the DDG and/or DDGS co-products that undergo the solvent extraction process of the present invention can provide a valuable animal feed supplement. In some aspects, the DDG and/or DDGS co-products that undergo the denaturing process of the present invention can provide a valuable animal feed supplement for ruminant animals. In some aspects, the ruminant animals that may be fed the DDG and/or DDGS co-products that are processed according the denaturing process of the present invention may be fed the resulting DDG and/or DDGS co-products, such as dairy cows to increase milk production.

In some aspects, the denaturing process of input DDGS byproduct according to certain embodiments of the present invention changes the composition of the resulting DDGS co-product by further denaturing the protein to levels which are not normally found in DDGS byproducts that undergo typical ethanol processing.

In particular, DDGS co-product under normal ethanol processing have been subjected to heat and solvent (i.e., ethanol only) during the production of ethanol. While such exposure to heat and/or solvent would be expected to impact the molecular shape of proteins (i.e., denaturing the proteins), DDGS co-product under normal ethanol processing have not been subjected to exposure to a non-polar solvent and additional thermal processing of the present invention as discussed below (i.e., heating prior to solvent extraction, desolventization post-extraction, and/or drying). The combined heat history of the DDGS co-product during the solvent extraction process of the present invention results in greater denaturing of the protein in the de-oiled DDGS byproduct than the exposure to solvent. In some aspects, the solvent extraction of de-oiled DDGS according to certain embodiments of the present invention changes the composition of the DDGS byproduct such that the resulting DDGS co-product contains higher measurable rumen undegradable protein (RUP).

In some aspects, the levels of RUP in the resulting DDGS co-product are increased between about 5% and up to about 25% or more compared to the input DDGS byproduct. In some aspects, the levels of RUP in the resulting DDGS co-product are increased between about 10% up to about 25% compared to the input DDGS byproduct.

In some aspects, the total protein content of the resulting DDGS co-product has greater than about 60% RUP. In some aspects, the levels of RUP in the DDGS co-product are about 5% to about 25% or more compared to the input DDGS byproduct. In some aspects, the levels of RUP in the DDGS co-product are about 10% to about 25% more compared to the input DDGS byproduct.

In some aspects, the total protein content of the resulting DDGS co-product has greater than about 55% intestinally absorbable digestible protein.

In some aspects, the DDGS co-product of the present invention contain a high RUP protein component, often referred to as bypass proteins, which are able to survive the rumen of a ruminant animal during the digestive process, such that more protein is bioavailable to the ruminant animal in the later stages of digestion, which results in greater protein absorption. In some aspects, the greater protein absorption occurs in dairy cows, which increase milk production.

In some aspects, serum blood urea nitrogen (BUN) values of blood samples taken from dairy cows that have been fed DDGS co-products of the present invention confirm the delivery of more nitrogen to the blood of the animals, which is indicative of increased absorbed protein. Without wishing to be bound by theory, it is contemplated that the increased protein absorption is the result of RUP and the later stages of digestion beyond the rumen of the ruminant animal.

In some aspects, the DDGS co-product undergoes a particle size reduction prior to the solvent extraction process of the present invention. In some aspects, the reduction of particle size prior to the solvent extraction process of the present invention results in DDGS co-product having desired RUP content.

In some aspects, the DDGS co-product of the present invention may be used in soil applications. In some aspects, a dry granular form of the DDGS co-product of the present invention provides extended/sustained release of nitrogen to the soil while slowly biodegrading compared to free nitrogen applications. In some aspects, the DDGS co-product of the present invention include amino acids, peptides and other organic compounds, which may have anti-fungal and/or anti-microbial properties. The DDGS co-products of the present invention may also be used to help support improved microbiological health and microbe populations in the soil.

In some aspects, the slower biodegradation of the DDGS co-product of the present invention provides a sustained release of amino acids, peptides and other organic compounds to the soil during decomposition. The use of such DDGS co-product may produce healthier soils, resulting in higher plant yields, better color turf, and better resistance of the plants to injury and disease.

In some aspects, the DDGS co-products of the present invention may be used in various horticulture and fertilizer applications, including commercial agriculture, turf and landscaping, and ornamental plant applications. In some aspects, the DDGS co-products of the present invention can be used alone, or in some aspects in combination with other agricultural processing by-products.

In some aspects, the DDGS co-products of the present invention can be provided in a dry (native) granular form, micro ground form and/or coated form, which may include hydrophilic gels, slow release agents, colored coatings, other premix additives, and/or be micro encapsulated. In some aspects, the DDGS co-products of the present invention can be in a water dispersible form (with or without emulsifiers and/or dispersing agents and/or surfactants), which are applied by a liquid application. In some aspects, the DDGS co-product of the present invention can be dispersed in water and applied thru a spray nozzle for application to soil.

Solvent Extraction of Crude Oil from DDGS and/or DDG

Using solvent extraction processes, commercially significant amounts of crude plant oils can be isolated from DDGS, while maintaining the value of DDGS as a feed supplement, herbicide and/or fertilizer In one embodiment, the DDGS used in a solvent extraction process as described herein are selected from DDGS generated in ethanol production processes that utilize corn, barley, rye, sorghum and/or soybean grain. In another embodiment, the DDGS used in a solvent extraction process are corn DDGS generated from a dry-grind corn ethanol biorefinery.

Solvent extraction processes suitable for extraction of crude oil from DDGS include processes that utilize ethanol, hexane, iso-hexane, petroleum distillate, mixtures thereof, or one or more other suitable solvents, as known in the art, for oil extraction of DDGS. One of ordinary skill in the art will appreciate that such solvents may be commercial grade or reagent grade solvents. In some aspects, solvent extraction processes suitable for extraction of crude oil from DDGS or crude corn oil form corn DDGS include processes that utilize suitable non-polar solvents that have a high solvent power for lipids, are commercially available, are acceptable regulatory-recognized solvents and/or can be readily removed from the resulting product by commonly accepted methods such as distillation, washing and/or evaporation.

In some aspects, suitable non-polar solvents comprise saturated hydrocarbons, such as one or more C₅-C₇-alkanes, particularly n-pentane, n-hexane and n-heptane, as well as the structural isomers thereof (i.e., isopentane, neopentane, isohexane, 2-methylepentane, 2,3-dimethylbutane, neohexane, isoheptane, 2-methylhexane, 2,2-dimethylpentane, 2,3-dimethylpentane, 2,4-dimethylpentane, 3-ethylpentane, and 2,2,3-trimethylbutane), petroleum ether, or mixtures thereof. In some aspects, suitable non-polar solvents or mixtures thereof have a boiling point in the range from about 36° C. to about 99° C. In some aspects, the non-polar solvents may be purified or commercial grade. For example, in some aspects, a suitable non-polar solvent includes commercial grade hexane, which one of ordinary skill in the art will appreciate comprises a mixture of n-hexane, other isomers of hexane and small amounts of other miscellaneous hydrocarbons (i.e., acetone, methyl ethyl ketone, dicloromethane, and trichloroethylene, aromatics such as toluene and/or other types of petroleum hydrocarbons).

In some aspects, suitable solvents comprise mixtures of solvents containing alkanes or blends of polar and non-polar solvents that form azeotropes. For example, suitable blends of polar and non-polar solvents may include hexane:ethanol or hexanelsopropanol. Such solvents may also include ketones such as acetone. In some aspects, the azeotrope comprises a blend of polar and non-polar solvents, such that the blend is a positive azeotrope, which has a boiling point at a lower temperature than any other ratio of its constituents.

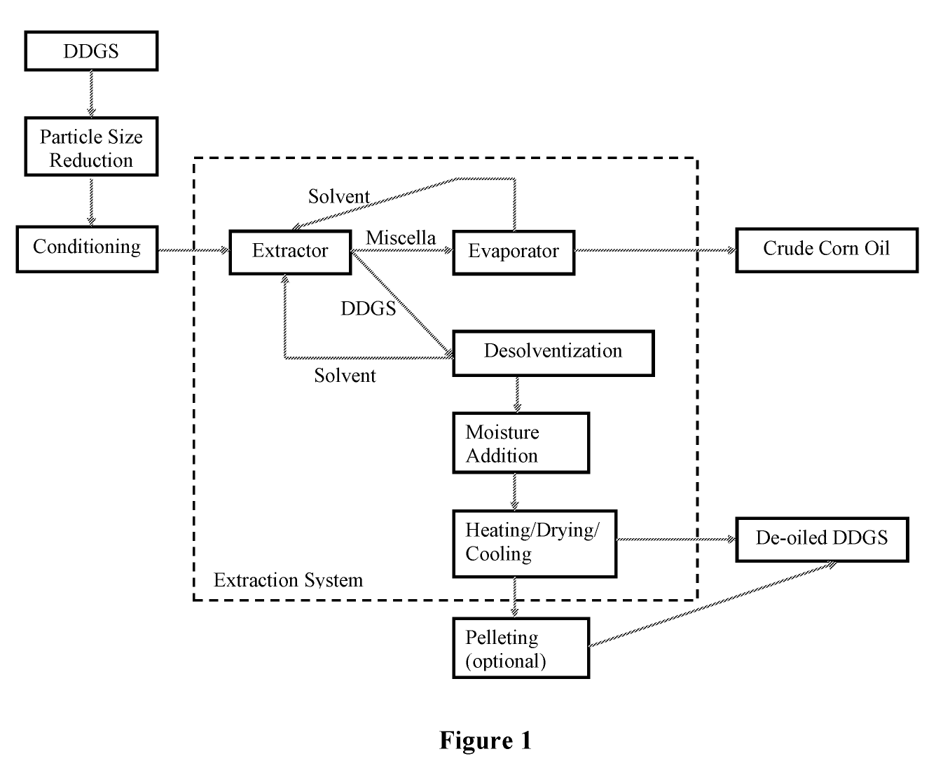

In one embodiment, the solvent extraction process utilizes a solvent, such as, for example, hexane that serves to remove oil from the DDGS without substantially altering the protein or fiber content of the DDGS. Oil extraction of the DDGS as described herein yields a distillers meal. In one embodiment, the solvent extraction process removes about 60% or more, about 65% or more, about 70% or more, about 75% or more, about 80% or more, or about 90% or more of the oil present in the DDGS. In another embodiment, the solvent extraction process is a hexane extraction process that removes about 60% or more, about 65% or more, about 70% or more, about 75% or more, about 80% or more, or about 90% or more of the oil present in the DDGS. In yet another embodiment, the solvent extraction process is a hexane extraction process that removes about 75% or more, about 80% or more, or about 90% or more of the oil present in corn DDGS. In yet another embodiment, the solvent extraction process is an extraction process using a mixture of non-polar solvents having a boiling point range between about 36° C. to about 99° C. that removes about 60% or more, about 65% or more, about 70% or more, about 75% or more, about 80% or more, or about 90% or more of the oil present in DDGS, and in some aspects corn DDGS. In yet another embodiment, the solvent extraction process is an extraction process using an azeotrope of a polar solvent and an alkane solvent that removes about 75% or more, about 80% or more, or about 90% or more of the oil present in DDGS, and in some aspects corn DDGS. In yet another embodiment, the solvent extraction process is a hexane extraction process that removes about 60% or more, about 65% or more, about 70% or more, about 75% or more, about 80% or more, or about 90% or more of the oil present in DDGS produced at a dry-grind corn ethanol biorefinery. Corn DDGS typically include about 5% up to about 15% by weight oil content, and in one embodiment, the solvent extraction process is a hexane extraction process that results in a corn distillers meal having a residual oil content of approximately 2-3% by weight, in some other aspects approximately 0.25-5% by weight, in some other aspects approximately 1-4% by weight, and in still some other aspects approximately 0.25-3% by weight. In another embodiment, corn DDGS are subjected to a hexane extraction process that results in a corn distillers meal having a residual oil content of no more than 3.0% by weight, in some aspects no more than 2.5% by weight.

Where the DDGS are produced at a dry-grind corn ethanol biorefinery, a flow-chart representation of suitable hexane extraction process is shown in FIG. 1. In a typical dry-grind process for ethanol production from corn, the DDGS are a co-product derived from the corn mash after the starch has been converted to ethanol and the ethanol has been removed by distillation. The stillage is typically subjected to centrifugation, evaporation and drying to remove residual liquid content, resulting in DDGS. Methods of extracting crude corn oil from corn DDGS are discussed in Sing et al., “Extraction of Oil From Corn Distillers Dried Grains with Solubles”, Transactions of the ASAE 41 (6), 1775-1777 (1998), the teachings of which are incorporated by reference herein. In addition, solvent extraction technologies and equipment are available from, for example, Crown Iron Works Company of Minneapolis, Minn., U.S.A. Moreover, technology directed to removal of the oil from vegetable particles, removal of residual solvent from solvent extracted materials, and recovery of solvents used in solvent extraction processes are described in, for example, U.S. Pat. No. 6,996,917, U.S. Pat. No. 6,766,595, U.S. Pat. No. 6,732,454, and U.S. Pat. No. 6,509,051. These patents are assigned to Crown Iron Works Company, and the teachings of each of these patents are incorporated by reference herein.

Referring again to FIG. 1, which illustrates an embodiment of a solvent extraction process that may he applied to DDGS, as a first step, DDGS meal is fed into an extractor. In some aspects, the DDGS meal may optionally be ground before being fed into an extractor to reduce the particle size of the DDGS meal. In some aspects, the DDGS meal is ground such that about 80%, in some aspects about 85%, in some aspects about 90%, in some aspects about 95%, in some aspects about 99%, and in some aspects about 100% of the DDGS meal has a particle size less than about 1 millimeter. In some aspects about 90% of the ground DDGS meal has a particle size less than about 1 millimeter to about 150 microns, in some aspects less than about 840 microns to about 150 microns, in some aspects less than about 710 microns to about 150 microns, in some aspects less than about 595 microns to about 150 microns, and in some other aspects less than about 525 microns to about 150 microns. In other aspects, the DDGS meal is ground such that at least 95% of the DDGS meal has a particle size less than about 1 millimeter to about 150 microns, in some aspects less than about 840 microns to about 150 microns, in some aspects less than about 710 microns to about 150 microns, in some aspects less than about 595 microns to about 150 microns, and in some other aspects less than about 525 microns to about 150 microns. In some other aspects, the DDGS meal is ground such that about 99% of the DDGS meal has a particle size less than about 1 millimeter to about 150 microns, in some aspects less than about 840 microns to about 150 microns, in some aspects less than about 710 microns to about 150 microns, in some aspects less than about 595 microns to about 150 microns, and in some other aspects less than about 525 microns to about 150 microns.

In the extractor, the DDGS meal is washed with solvent, and in one embodiment, the DDGS meal is turned at least once in order to ensure that all DDGS particles are contacted as equally as practicable with solvent. After washing, the resulting mixture of oil and solvent, called miscella, is collected for separation of the extracted oil from the solvent. During the extraction process, as the solvent washes over the DDGS flakes, the solvent not only brings oil into solution, but may collect fine, solid DDGS particles. These “fines” are generally undesirable impurities in the miscella, and in one embodiment, the miscella is discharged from the separator through a device that separates or scrubs the fines from the miscella as the miscella is collected for separation of the oil from the solvent.

In order to separate the oil and the solvent contained in the miscella, the miscella may be subjected to a distillation step. In this step, the miscella can, for example, be processed through an evaporator, which heats the miscella to a temperature that is high enough to cause vaporization of the solvent, but is not sufficiently high to adversely affect or vaporize the extracted oil. The oil may be further stripped of solvent in an oil stripper to further reduce residual solvent levels. As the solvent evaporates, it may be collected, for example, in a condenser, and recycled for future use. Separation of the solvent from the miscella results in a stock of crude oil, which may be further processed to provide valuable products.

After extraction of the oil, the wet, de-oiled DDGS may be conveyed out of the extractor and subjected to a drying process that removes residual solvent. Removal of residual solvent is important to production of distillers meal suitable for use as an animal feed ingredient. In one embodiment, the wet meal can be conveyed in a vapor tight environment to preserve and collect solvent that transiently evaporates from the wet meal as it is conveyed into the desolventizer. As the meal enters the desolventizer, it may be heated to vaporize and remove the residual solvent. In order to heat the meal, the desolventizer may include a mechanism for distributing the meal over one or more trays, and the meal may be heated directly, such as through direct contact with heated air or steam, or indirectly, such as by heating the tray carrying the meal, or both. The desolventizer may further include multiple different trays for carrying the meal through different processing steps within the desolventizer. In order to facilitate transfer of the meal from one tray to another, the trays carrying the meal may include openings between trays that allow the meal to pass from one tray to the next.

Where the desolventizer utilizes multiple process steps to remove residual solvent from the wet, de-oiled DDGS to produce distillers meal, the wet, de-oiled DDGS may be loaded and transferred through various trays to facilitate heating and solvent removal in multiple process steps. For example, in one embodiment, as the meal enters the desolventizer, it may be loaded on a first group of heated trays where the meal is evenly distributed and solvent vapor is flashed from the meal. From this first set of trays, the meal may he transferred onto a second group of trays, where it is again evenly distributed. The second set of trays may be heated indirectly by steam. The trays may be designed to allow venting of the solvent from one tray to the next and the meal contained in the second set of trays travels counter current to the solvent vapors. A third tray or set of trays may be provided to allow direct steam injection into the meal, which works to strip remaining solvent. Where the desolventizer includes multiple trays and utilizes multiple desolventizing processes, the quantity of trays and their positions may be designed to allow maximum contact between vapors and meal.

From the desolventizer, the meal may be conveyed to a dryer where the meal is dried of residual excess water and cooled to provide a finished distillers meal. As it is conveyed into the dryer, the meal may be deposited into drying trays and it is warmed by heated air. As the meal is heated, residual water is vaporized. After drying, the meal may be cooled using ambient air. The desolventized, dried and cooled distillers meal may be stored, further processed, such as pelletizing to increase densification, or prepared for sale or distribution.

In some aspects, the desolventizing, toasting, drying and cooling processes can be accomplished in a single vessel referred to as a DTDC. In some aspects, the desolventizing and toasting processes are combined in one vessel, referred to as a DT, and the drying and cooling processes are combined in a separate vessel referred to as a DC. In some aspects, the desolventizing and toasting processes are conducted in a Crown® DT and the drying and cooling processes are conducted in a Crown® DC.

In some aspects, in the DDGS desolventizing, toasting, drying and cooling process steps, the solvent used to remove oil from the DDGS byproduct is removed from the de-oiled DDGS material and may be recovered for re-use, the de-oiled DDGS material is heated or toasted, the de-oiled DDGS material is dried to within acceptable moisture requirements, and the de-oiled DDGS material is cooled to near ambient temperature to remain flowabie during storage and transport. The resultant desolventized, toasted, dried and cooled DDGS product is commonly referred to herein as corn distillers meal.

In some aspects, steam is injected into the DDGS byproduct during the oil extraction desolventization step, the live steam creating a sparging process. In some aspects, the live steam is applied during the desolventization step for at least 20 minutes, in some other aspects at least 25 minutes, more preferably at least 30 minutes, and in some other preferable aspects between about 20 minutes and about 50 minutes. In some aspects, the drum has a lower screen that can be used to facilitate the desolventization process.

In some aspects, the de-oiled, desolventized DDGS undergoes the heating and drying step by applying airflow at a temperature between about 200° F. and about 325° F., more preferably between about 250° F. and about 310° F., more preferably between about 265° F. and about 310° F., and most preferably between about 275° F. and about 290° F., for a period of time between about 30 minutes to about 90 minutes, more preferably between about 40 minutes and about 80 minutes, most preferably between about 45 minutes and about 60 minutes, at a flow rate between about 15 CFM/T to about 75 CFM/T, more preferably between about 20 CFM/T to about 60 CFM/T, more preferably between about 25 CFM/T and about 50 CFM/T, and most preferably between about 25 CFM/T and about 30 CFM/T. In some aspects, the heating and drying steps are conducted in a DC having at least 3 dryer stacks, in some aspects in a DC having at least 4 dryer stacks, and in some other aspects in a DC having at least 5 dryer stacks.

In some aspects, after the heating and drying steps, the de-oiled, desensitized DDGS undergoes a cooling step. In some aspects, the de-oiled, desolventized, heated and dried DDGS is cooled in ambient air at a flow rate between about 25 CFM/T to about 60 CFM/T, more preferably between about 30 CFM/T to about 50 CFM/T, most preferably between about 35 CFM/T and about 45 CFM/T, for a period of time between about 5 minutes to about 30 minutes, more preferably between about 5 minutes and about 20 minutes, and most preferably about 10 minutes.

In some aspects, the desolventizing, toasting, drying and cooling processes can be accomplished in a single vessel referred to as a DTDC. In some aspects, the desolventizing and toasting processes are combined in one vessel, referred to as a DT, and the drying and cooling processes are combined in a separate vessel referred to as a DC. In the DDGS desolventizing, toasting, drying and cooling process path, the solvent used to remove oil from the DDGS byproduct is removed from the de-oiled DDGS material and may be recovered for re-use, the de-oiled DDGS material is heated or toasted, the de-oiled DDGS material is dried to within acceptable moistu requirements, and the de-oiled DDGS material is cooled to near ambient temperature to remain flowable during storage and transport. The resultant desolventized, toasted, dried and cooled DDGS product is commonly referred to herein as corn distillers meal.

In some aspects, at least about 80%, in some aspects about 85%, in some aspects about 90%, in some aspects about 95%, in some aspects about 99%, and in some aspects about 100% of the distillers meal has a particle size less than about 1 millimeter. In some aspects about 90% of the distillers al has a particle size less than about 1 millimeter to about 150 microns, in some aspects less than about 840 microns to about 150 microns, in some aspects less than about 710 microns to about 150 microns, in some aspects less than about 595 microns to about 150 microns, and in some other aspects less than about 525 microns to about 150 microns. In other aspects, about 95% of the distillers meal has a particle size less than about 1 millimeter to about 150 microns, in some aspects less than about 840 microns to about 150 microns, in some aspects less than about 710 microns to about 150 microns, in some aspects less than about 595 microns to about 150 microns, and in some other aspects less than about 525 microns to about 150 microns. In some other aspects, about 99% of the distillers meal has a particle size than about 1 millimeter to about 150 microns, in some aspects less than about 840 microns to about 150 microns, in some aspects less than about 710 microns to about 150 microns, in some aspects less than about 595 microns to about 150 microns, and in some other aspects less than about 5 microns to about 150 microns.

In some aspects, the distillers meal has an average particle size of about 105 microns to about 625 microns, in some aspects about 150 microns to about 600 microns, in some aspects about 175 microns to about 575 microns, in some aspects about 200 microns to about 525 microns, and in some aspects about 250 microns to about 500 microns.

In some aspects, the distillers meal may comprise a residual level of solvent utilized in the solvent extraction process in an amount of about 10 ppm to about 2000 ppm, in other aspects about 10 ppm to about 1000 ppm, in other aspects about 10 ppm to about 500 ppm, and still in some other aspects about 10 ppm to about 100 ppm. In some aspects, a residual level of hexane solvent is present in the distillers meal in an amount of about 10 ppm to about 2000 ppm, in other aspects about 10 ppm to about 1000 ppm, in other aspects about 10 ppm to about 500 ppm, in other aspects about 10 ppm to about 100 ppm, and in still other aspects about 100 ppm to about 500 ppm. In some aspects, a residual level of hexane solvent is present in the corn distillers meal in an amount of about 10 ppm to about 2000 ppm, in other aspects about 10 ppm to about 1000 ppm, in other aspects about 10 ppm to about 500 ppm, in other aspects about 10 ppm to about 100 ppm, and in still other aspects about 100 ppm to about 500 ppm.

In some aspects, the distillers meal may comprise a residual moisture content of about 3% to about 15%, in some aspects about 4% to about 13%, and still in other aspects about 7% to about 11%.

The biorefining and solvent extraction processes may be tailored to provide extracted oil exhibiting specific qualities. For example, where the DDGS are corn DDGS and the solvent extraction process is a hexane extraction process, the biorefining and solvent extraction process may be controlled to provide an extracted crude corn oil exhibiting no more than about 15% by weight free fatty acids, such as oleic acid, no more than about 1% by weight crude protein, about 0.5% by weight total nitrogen, 0.2% by weight ash, about 0.05% phosphorus, about 0.01% by weight potassium, about 0.005% sodium, or about 0.05% by weight sulfur, or any combination of one or more such qualities. In one such embodiment, the crude corn oil includes no more than about 0.6%, 0.7%, 0.8% or 0.9% by weight crude protein. In another such embodiment, the crude corn oil contains no more than about 10%, 11%, 12%, 13%, 14%, or 15% by weight free fatty acids. In another such embodiment, the crude corn oil contains free fatty acids in an amount between about 1% to about 15%, in some aspects between about 1% and about 14%, in some aspects between about 1% and about 13%, in some aspects between about 1% and about 12%, in some aspects between about 1% and about 11%, in some aspects between about 1% and about 10%, in some aspects between about 1% and about 9%, in some aspects about 1% and about 8%, in some aspects about 3% to about 15%, by weight of the crude corn oil, with other ranges and subranges of the foregoing ranges contemplated. In another such embodiment, the crude corn oil contains no more than about 0.09%, 0.1%, 0.2%, 0.25%, 0.3%, or 0.4% by weight total nitrogen. In yet another such embodiment, the crude corn oil contains no more than about 0.08%, 0.09%, 0.1%, or 0.15% by weight ash. In another such embodiment, the crude corn oil contains about 200 to about 1200 ppm, in some other aspects about 300 ppm to about 1000 ppm, in some other aspects, about 350 ppm to about 800 ppm, and in some other aspects about 500 ppm to about 800 ppm of phosphorus. In yet another such embodiment, the crude corn oil contains no more than about 0.02%, 0.03%, or 0.04% by weight potassium. In yet another such embodiment, the crude corn oil contains no more than about 0.003% or 0.004% by weight sodium. In yet another such embodiment, the crude corn oil contains no more than about 0.02%, 0.03%, or 0.04% by weight sulfur.

It is contemplated that where the DDGS is corn DDGS and the solvent extraction process utilizes other solvents or mixtures of solvents containing alkanes, the biorefining and solvent extraction process may be controlled to provide an extracted crude oil exhibiting no more than about 15% by weight free fatty acids, such as oleic acid, no more than about 1% by weight crude protein, 0.5% by weight total nitrogen, 0.2% by weight ash, 0.05% phosphorus, 0.01% by weight potassium, 0.005% sodium, or 0.05% by weight sulfur, or any combination of one or more such qualities. In one such embodiment, the crude corn oil includes no more than about 0.6%, 0.7%, 0.8% or 0.9% by weight crude protein. In another such embodiment, the crude oil contains no more than about 10%, 11%, 12%, 13%, 14%, or 15% by weight free fatty acids. In another such embodiment, the crude corn oil contains free fatty acids in an amount between about 1% to about 15%, in some aspects between about 1% and about 14%, in some aspects between about 1% and about 13%, in some aspects between about 1% and about 12%, in some aspects between about 1% and about 11%, in some aspects between about 1% and about 10%, in some aspects between about 1% and about 9%, in some aspects about 1% and about 8%, in some aspects about 3% to about 15%, by weight of the crude corn oil, with other ranges and subranges of the foregoing ranges contemplated. In another such embodiment, the crude corn oil contains no more than about 0.09%, 0.1%, 0.2%, 0.25%, 0.3%, or 0.4% by weight total nitrogen. In yet another such embodiment, the crude corn oil contains no more than about 0.08%, 0.09%, 0.1%, or 0.15% by weight ash. In another such embodiment, the crude corn oil contains about 200 to about 1200 ppm, in some other aspects about 300 ppm to about 1000 ppm, in some other aspects, about 350 ppm to about 800 ppm, and in some other aspects about 500 ppm to about 800 ppm of phosphorus. In yet another such embodiment, the crude corn oil contains no more than about 0.01%, 0.02%, 0.03%, or 0.04% by weight potassium. In yet another such embodiment, the crude corn oil contains no more than about 0.003% or 0.004% by weight sodium. In yet another such embodiment, the crude corn oil contains no more than about 0.02%, 0.03%, or 0.04% by weight sulfur.

In some aspects, the crude oil extracted utilizing a solvent extraction process on DDGS comprises a residual level of solvent utilized in the solvent extraction process in an amount of about 1 ppm to about 500 ppm, in other aspects about 10 ppm to about 400 ppm, in other aspects about 1 ppm to about 100 ppm, and still in some other aspects about 10 ppm to about 100 ppm. In some aspects, a residual level of solvent is present in the crude corn oil extracted from corn DDGS, the residual level of hexane present in the crude oil present in an amount of about 1 ppm to about 500 ppm, in other aspects about 10 ppm to about 400 ppm, in other aspects about 1 ppm to about 100 ppm, and still in some other aspects about 10 ppm to about 100 ppm. In some aspects, a residual level of hexane solvent is present in the crude oil extracted from DDGS, the residual level of hexane present in the crude oil present in an amount of about 1 ppm to about 500 ppm, in other aspects about 10 ppm to about 400 ppm, in other aspects about 1 ppm to about 100 ppm, and still in some other aspects about 10 ppm to about 100 ppm. In some aspects, a residual level of hexane solvent is present in the crude corn oil extracted from corn DDGS, the residual level of hexane present in the crude oil present in an amount of about 1 ppm to about 500 ppm, in other aspects about 10 ppm to about 400 ppm, in other aspects about 1 ppm to about 100 ppm, and still in some other aspects about 10 ppm to about 100 ppm.

### Distillers Meal

The distillers meal produced by a solvent extraction method as described herein retain desired nutritional properties. The solvent extraction process applied to the DDGS may be chosen and tailored to provide a distillers meal that exhibits nutritional properties suitable for animal feed supplement, horticultural and/or fertilizer applications.

For example, in one embodiment, the DDGS are subjected to a solvent extraction process that provides distillers meal that retains substantially all the crude protein and fiber content of the DDGS prior to solvent extraction. In another embodiment, the distillers meal is corn distillers meal that retains substantially all of the crude protein and fiber content of the DDGS prior to solvent extraction. In yet another embodiment, distillers meal is corn distillers meal that retains substantially all of the crude protein and fiber content of the DDGS prior to solvent extraction and is the product of a hexane extraction process conducted on corn DDGS produced by a dry-grind corn ethanol biorefinery.

For example, where the DDGS are corn DDGS and the solvent extraction process is a hexane extraction, the biorefining and solvent extraction processes may be controlled to provide corn distillers meal having the following nutrient content by weight on a dry matter basis: about 28% to about 35% crude protein; about 4% to about 6% total nitrogen; about 1% to about 5% crude fat; about 4% to about 6% ash; about 5% to about 7% crude fiber; about 11.5% to about 16.5% acid detergent fiber; about 25% to about 35% neutral detergent fiber; about 50% to about 55% nitrogen free extract; about 75% to about 80% total digestible nutrients (“TDN”); or a combination of two or more of any of the forgoing nutritional properties. In another embodiment, where the DDGS are corn DDGS and the solvent extraction process is a hexane extraction, the biorefining and solvent extraction processes may be controlled to provide corn distillers meal exhibiting about 0.80 to about 0.85 Meal/lb net energy lactation (NE/Lactation), about 0.85 to about 0.89 Mcal/lb net energy maintenance (NE/maintenance), about 1200 to about 1250 kcal/lb of metabolizable energy, or about 0.55 to about 0.60 Meal/lb of net energy gain (NE/gain), or any combination of two or more such characteristics.

It is contemplated that where the DDGS are corn DDGS and the solvent extraction process utilizes other solvents or mixtures of solvents containing alkanes, the biorefining and solvent extraction process may be controlled to provide corn distiller meal having the following nutrient content by weight on a dry matter basis: about 28% to about 35% crude protein; about 4% to about 6% total nitrogen; about 1% to about 5% crude fat; about 4% to about 6% ash; about 5% to about 7% crude fiber; about 11.5% to about 16.5% acid detergent fiber; about 25% to about 35% neutral detergent fiber; about 50% to about 55% nitrogen free extract; about 75% to about 80% total digestible nutrients (“TDN”); or a combination of two or more of any of the forgoing nutritional properties. In another embodiment, where the DDGS are corn DDGS and the solvent extraction process is a hexane extraction, the biorefining and solvent extraction processes may be controlled to provide corn distillers meal exhibiting about 0.80 to about 0.85 Meal/lb net energy lactation (NE/Lactation), about 0.85 to about 0.89 Meal/lb net energy maintenance (NE/maintenance), about 1200 to about 1250 kcal/lb of metabolizable energy, or about 0.55 to about 0.60 Meal/lb of net energy gain (NE/gain), or any combination of two or more such characteristics.

In certain other aspects, it is contemplated that where the DDGS are corn DDGS and the solvent extraction process utilizes other solvents or mixtures of solvents containing alkanes, the biorefining and solvent extraction process may be controlled to provide corn distillers meal having the following nutrient content by weight on a dry matter basis: about 28% to about 35% crude protein; about 4% to about 6% total nitrogen; about 0.5% to about 6% crude fat; about 4% to about 6% ash; about 5% to about 7% crude fiber; about 10% to about 20% acid detergent fiber; about 25% to about 35% neutral detergent fiber; about 50% to about 55% nitrogen free extract; about 75% to about 80% total digestible nutrients (“TDN”); or a combination of two or more of any of the forgoing nutritional properties. In another embodiment, where the DDGS are corn DDGS and the solvent extraction process is a hexane extraction, the biorefining and solvent extraction processes may be controlled to provide corn distillers meal exhibiting about 0.70 to about 0.85 Mcal/lb net energy lactation (NE/Lactation), about 0.85 to about 0.89 Mcal/lb net energy maintenance (NE/maintenance), about 1200 to about 1250 kcal/lb of metabolizable energy, or about 0.55 to about 0.60 Mcal/lb of net energy gain (NE/gain), or any combination of two or more such characteristics.

The distillers meal may be further processed, as desired, to provide a distillers meal product having desired characteristics, such as, for example, a desired flowabilty or density. Moreover, the distillers meal may be further processed to provide a product that is more easily packaged and distributed as an ingredient in a feed. Even further, the distillers meal may be processed to incorporate additional constituents to increase the feeding paltability or nutritional quality. For example, in one embodiment, the distillers meal may be further processed to incorporate a salt or a syrup from another manufacturing process that provides additional protein content. In another embodiment, the distillers meal may be pelleted to provide a feed material that is more readily packaged for sale and transport and is more easily incorporated into or used as an animal feed. For instance, Example 2 provides a description of an embodiment of corn distillers meal according to the description provided herein, as well as suitable process conditions for pelletizing the corn distillers meal described therein. Tables presented in Example 2 set out the process conditions under which the corn distillers meal was pelletized, describe a selection of physical properties exhibited by the non-pelleted and the pelleted corn distillers meal, and highlight a selection of nutritional properties exhibited by the non-pelleted and the pelleted corn distillers meal.

In some aspects, the solvent extracted crude oil from DDGS enhances the nutritional profile of the distillers meal by increasing the percentage of protein and amino acids contained in the distillers meal. For example, conventional corn DDGS having a corn oil content of about 10% typically has a lysine content of about 0.75% by weight on a dry matter basis. In comparison, corn distillers meal of the present invention that has a residual corn oil content of about 2% has a lysine content of about 0.81% by weight on a dry matter basis. This increase in lysine content in the corn distillers meal, when compared to the ratio of residual fat, results in a lysine to residual fat ratio percentage (% lysine/% residual fat)*100 of about 7.5 for conventional corn DDGS, as compared to a lysine to residual fat ratio of about 40.5 for corn distillers meal of the present invention.

In some aspects, the lysine content of corn distillers meal ranges from about 0.7% to about 1.0% for corn distillers meal having a residual fat content between about 0.5% to about 3.0%. As a result, the lysine to residual fat ratio for corn distillers meal is between about 23.3 to about 140 at a lysine content of about 0.7%, between about 26.7 and about 160 at a lysine content of about 0.8%, between about 30 and about 180 at a lysine content of about 0.9%, and between about 33.3 and about 200 at a lysine content of about 1.0%. Thus, corn distillers meal of the present invention may have a lysine to residual fat ratio between about 20 to about 200, in sonic aspects about 25 to about 180, in some aspects about 30 to about 160, and in some other aspects about 40 to about 140, with other ranges and subranges of the foregoing ranges contemplated herein. In comparison to an ethanol plant employing the CSO recovery method, and assuming a high native lysine content of about 0.9% and a residual fat content of about 4%, the lysine to residual fat ratio would at the very most be about 20.

When one or more of the specific fatty acids in the residual fat composition of the corn distillers meal are considered as opposed to the total residual fat, such as linoleic acid (C18:2) or oleic acid (C18:1), the atios are further enhanced. For example, in the situation of linoleic acid, which is about 45% to about 60% of the total fatty acid content, and for the sake of this example assumed to be 50%, the lysine to linoleic acid ratio in corn distillers meal is in the range of about 46.6 to about 280 at a lysine content of about 0.7%, between about 53.4 and about 320 at a lysine content of about 0.8%, between about 60 and about 360 at a lysine content of about 0.9%, and between about 66.6 and about 400 at a lysine content of about 1.0%. Thus, corn distillers meal of the present invention may have a lysine to residual linoleic acid ratio between about 45 to about 400, in some aspects about 50 to about 360, in some aspects about 60 to about 320, and in some other aspects about 80 to about 280, with other ranges and subranges of the foregoing ranges contemplated herein. In comparison to an ethanol plant employing the CSO recovery method, and assuming a high native lysine content of about 0.9% and a residual fat content of about 4%, the lysine to residual linoleic acid ratio would at the very most be about 40.

When oleic acid is used as the specific fatty acid instead of the total residual fat or linoleic acid, the ratios are even further enhanced. For example, in the situation of oleic acid, which is about 20% to about 40% of the total fatty acid content, and for the sake of this example assumed to be 25%, the lysine to oleic acid ratio in corn distillers meal is in the range of about 85 to about 560 at a lysine content of about 0.7%, between about 105 and about 640 at a lysine content of about 0.8%, between about 120 and about 720 at a lysine content of about 0.9%, and between about 125 and about 800 at a lysine content of about 1.0%. Thus, corn distillers meal of the present invention may have a lysine to residual oleic acid ratio between about 85 to about 800, in some aspects about 105 to about 720, in some aspects about 120 to about 640, and in some other aspects about 160 to about 560, with other ranges and subranges of the foregoing ranges contemplated herein. In comparison to an ethanol plant employing the CSO recovery method, and assuming a high native lysine content of about 0.9% and a residual fat content of about 4%, the lysine to residual linoleic acid ratio would at the very most be about 40.

Conventionally, the protein content percentage in meals, such as flours, grains and oilseeds, is defined as the total nitrogen times 6.25, for example 1% total nitrogen equals 6.25% protein. In conventional DDGS, including corn DDGS, the ratio of total nitrogen to total free fatty acids is less than 25. In distillers meal of the present invention, including corn distillers meal, the ratio of total nitrogen to total free fatty acids is greater than 25 up to about 200, in some aspects about 35 to about 200, and still in other aspects about 50 to about 200. In some aspects of the present invention, the total free fatty acid content in solvent extracted oil is about 2% to about 10%, in some aspects about 3% to about 9%, and in some aspects about 5% to about 8%, and in some further aspects about 7% to about 8%. In comparison, the fatty free acid content resulting from the CSO recovery method would be inherently higher due to the hydrolytic splitting of the oil in the presence of water required for the CSO recovery method. As such, a free fatty acid content of about 10% or even higher for the CSO recovery method is not unusual.

### Distillers Meal as an Animal Feed Ingredient

DDGS are often used as a feed supplement for livestock and poultry fed high grain content finishing diets. Before solvent extraction, DDGS may have approximately 30% by weight crude protein (“CP”) and 20% crude fiber (“CF”). Solvent extraction as described herein removes most of the oil from the DDGS so that such oil can be processed or refined to provide additional products of commercial value. However, because most of the oil present DDGS is removed in producing distillers meal, the energy potential of the distillers meal from the fat content is lower han that exhibited by the DDGS prior to solvent extraction. Despite the lower energy potential resulting from oil extraction, distillers meal as described herein provides a high-quality, low-cost protein ingredient that can be fed at higher inclusion rates for animals, such as domestic pets, livestock or poultry. In addition, as described herein, livestock feed distillers meal exhibit desirable carcass traits, and the nutritional properties of distillers meal may provide a superior feed or feed supplement. Accordingly, in certain aspects, the DDGS processed according to certain processes as provided herein to produce distillers meal can be used as livestock feed, such as supplementing animal diets or as an animal feed.

In one embodiment, the distillers meal disclosed herein may be used to supplement animal diets at a desired percentage of the total diet, on a dry matter basis. In one embodiment, the distillers meal may be used as a CP supplements in livestock and poultry feed diets. In addition, the distillers meal described herein may also be used as an animal feed or feed supplement that provides desired amounts of carbohydrates, fiber or non-protein nitrogen (NPN) containing compounds. The distillers meal can be used at a percentage of the total feed that maximizes the nutritional components of the feed. The relative amount of distillers meal incorporated into an animal diet may depend on, for example, the species, sex, or agricultural use of the animal being fed. Additionally, the relative amount of distillers meal incorporated into a particular diet may depend on the nutritional goals of the diet.

In one embodiment, distillers meal may be used to provide approximately 50% to approximately 75% by weight, on a dry matter basis, of a total diet for use in an animal feed. In one such embodiment, the distillers meal is corn distillers meal as described herein and is used to provide approximately 50% to 55%, 50% to 60%, 50% to 65%, or 50% to 70% by weight, on a dry matter basis, of the total diet. In some aspects, the distillers meal is substituted in an animal feed diet for soybean meal, corn, DDGS and/or other protein supplements in rations for such animal. In another such embodiment, the distillers meal is corn distillers meal as described herein and is used to provide approximately 50% to 55%, 55% to 60%, 55% to 70%, 60% to 65%, 60% to 70%, or 70% to 75% by weight, on a dry matter basis, of the total diet. In some aspects, the corn distillers meal is substituted in an animal feed diet for soybean meal, corn, DDGS and/or other protein supplements in rations for such animal.

In another embodiment, distillers meal as described herein may be used to provide approximately 0 to 5%, approximately 5% to 10%, approximately 5% to 15%, approximately 5% to 25%, approximately 5% to 30%, approximately 10% to 15%, approximately 15% to 20%, approximately 20% to 25%, approximately 25% to 30%, approximately 30% to 35%, approximately 35% to 40%, approximately 40% to 45%, or approximately 45% to 50% by weight, on a dry matter basis, of a total animal diet. In one such embodiment, distillers meal as described herein is used as a CP supplement in a cattle diet, and the distillers meal provides approximately 5% to 20% by weight, on a dry matter basis, of the total diet. In yet another such embodiment, distillers meal as described herein is used as a CP supplement in a cattle diet, and the distillers meal provides approximately 5% to 15% by weight, on a dry matter basis, of the total diet. In still yet another such embodiment, distillers meal as described herein is used as a CP supplement in a cattle diet, and the distillers meal provides approximately 10% to 15% by weight, on a dry matter basis, of the total diet. In yet another such embodiment, distillers meal as described herein is used as a CP supplement in a cattle diet, and the distillers meal provides approximately 10% to 12% by weight, on a dry matter basis of the total diet. In another such embodiment, distillers meal as described herein is used as a CP supplement in a cattle diet, and the distillers meal provides approximately 7% to 12% by weight, on a dry matter basis, of the total diet. In each of the preceding embodiments, where the distillers meal is fed to cattle, the distillers meal may be corn distillers meal as described herein and the cattle may be finishing cattle.

In another embodiment, distillers meal as described herein may be used in feeding dairy cattle. Where corn distillers meal is used as a dairy cattle feed, it may be provided at, for examples, up to approximately 30%, approximately 5% to 30%, approximately 5% to 25%, approximately 5% to 20%, approximately 5% to 15%, approximately 10% to 15%, approximately 15% to 20%, approximately 15% to 25%, approximately 15% to 30%, approximately 10% to 20%, approximately 10% to 25%, approximately 20% to 25%, or approximately 25% to 30% by weight, on a dry matter basis, of the total diet. In each of the exemplary embodiments, where the distillers meal is fed to dairy cattle, the distillers meal may be corn distillers meal as described herein.

In another embodiment, distillers meal as described herein is used as a feed supplement for cattle to achieve a desired FIG ratio. As it is used herein, the term “F/G ratio” refers to the ratio of pounds of feed per pound of daily gain. In one embodiment, distillers meal as described herein is used as a cattle feed supplement to achieve an FIG ratio of 4.5 or less after 4 weeks of feeding. In another embodiment, distillers meal as described herein is used as a cattle feed supplement to achieve an F/G ratio of 5.0 or less after 8 weeks of feeding. In yet another embodiment, distillers meal as described herein is used as a cattle feed supplement to achieve an F/G ratio of 6.5 or less after 12 weeks of feeding. In yet another embodiment, distillers meal as described herein is used as a cattle feed supplement to achieve an F/G ratio of 7.0 or less after 16 weeks of feeding. In yet another embodiment, distillers meal as described herein is used as a cattle feed supplement to achieve an F/G ratio of 6.5 or less through 18 weeks of feeding. In each of the embodiments described herein pertaining to use of distillers meal as a feed supplement in cattle to achieve a desired F/G ratio, the distillers meal may be corn distillers meal, the cattle may be, for example, finishing cattle, and the corn distillers meal may provide, for example, approximately 5% to 15%, 5% to 10%, 7%-12%, or 10% to 12% by weight, on a dry matter basis, of the total diet. Alternatively, in each of the embodiments described herein pertaining to use of distillers meal as a feed supplement in cattle to achieve a desired F/G ratio, the distillers meal may be corn distillers meal, the cattle may be, for example, finishing cattle, and the corn distillers meal may provide, for example, approximately 5%, 6%, 7%, 8%, 9%, 10%, 11%, 12%, 13%, 14%, or 15% by weight, on a dry matter basis, of the total diet.

In yet another embodiment, distillers meal as described herein may be used as a feed supplement for cattle to achieve a desired average daily gain (ADG). in one embodiment, distillers meal as described herein is used as a cattle feed supplement to achieve an ADG of 4.0 lbs or greater after 4 weeks of feeding. In another embodiment, distillers meal as described herein is used as a cattle feed supplement to achieve an ADG of 4.5 lbs or greater after 8 weeks of feeding. In yet another embodiment, distillers meal as described herein is used as a cattle feed supplement to chieve an ADG of 3.5 lbs or greater after 12 weeks of feeding. In yet another embodiment, distillers meal as described herein is used as a cattle feed supplement to achieve and maintain an ADG of 3.5 lbs or greater through 16 weeks of feeding. In yet another embodiment, distillers meal as described herein is used as a cattle feed supplement to achieve and maintain an ADG of 3.5 lbs or greater through 18 weeks of feeding. In yet another embodiment, distillers meal as described herein is used as a cattle feed supplement to achieve an ADG of 4.0 lbs or greater after 18 weeks of feeding. In each of the embodiments described herein pertaining to use of distillers meal as a feed supplement in cattle to achieve a desired ADG, the distillers meal may be corn distillers meal, the cattle may be, for example, finishing cattle, and the corn distillers meal may provide, for example, approximately 5% to 15%, 5% to 10%, 7%-12%, or 10% to 12% by weight, on a dry matter basis, of the total diet. Alternatively, in each of the embodiments described herein pertaining to use of distillers meal as a feed supplement in cattle to achieve a desired ADG, the distillers meal may be corn distillers meal, the cattle may be, for example, finishing cattle, and the corn distillers meal may provide, for example, approximately 5%, 6%, 7%, 8%, 9%, 10%, 11%, 12%, 13%, 14%, or 15% by weight, on a dry matter basis, of the total diet.

The distillers meal may be provided in meal form or in pellet form or other forms useful for feeding livestock or poultry, as would be recognized in the art. The distillers meal may also be premixed with other desired ingredients of a livestock or poultry diet and provided for use in a ready-to-feed form. In addition to distillers meal as described herein, livestock and poultry diets as described herein may further include, for example, desired percentages of other components such as feed corn, corn meal, soybean meal, urea, hay, pre-prepared cattle feeds, protein supplements, mineral supplements, liquid supplements and other feed components as known and used by those of skill in the art. Other acceptable materials used in livestock and poultry feed may include, for example, soybeans, soy hulls, soybean protein derivatives, wheat, wheat middling, wheat straw, alfalfa, sugar beet tailings, sugar beet pulp, sugar beets, corn stalks, corn cobs, popcorn husks, sweet bran, silage, meat and bone meal, molasses, oats, oat straw, barley, barley straw, sunflower seeds and hulls, milo, and wild grass, cottonseed by-products, such as delinted whole cottonseed, fuzzy cottonseed, and by-products of other oil seeds.

In some aspects, the distillers meal as described herein is used as a feed supplement or formula feed for beef cattle, including the beef cattle classes of calves, cattle on pasture and/or feedlot cattle. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a maximum percentage of equivalent crude protein from non-protein nitrogen of about 6%, in some aspects about 5%, and in some aspects about 4%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; a minimum percentage of phosphorous in an amount of about 0.7%, in some aspects about 0.75%, and in some other aspects about 0.8%; and a minimum percentage of potassium in an amount of about 0.8%, in some aspects about 0.85%, in some aspects about 0.9%, in some aspects about 0.95%, and in some other aspects about 1.0%.

In some aspects, the distillers meal as described herein is used as a feed supplement or feed formula for dairy cattle, particularly veal milk replacer and/or herd milk replacer. The distillers meal may have a minimum percentage of crude protein in an amount of about 28%, in some aspects about 29%, in some aspects about 30%, in some aspects about 31%, in so aspects about 32%, in some aspects about 33%, in some aspects about 34%, and in some aspects about 35%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; and a minimum percentage of phosphorous in an amount of about 0.8%, in some aspects about 0.85%, in some aspects about 0.9%, in some aspects about 0.95%, and in some other aspects about 1.0%.

In some aspects, the distillers meal as described herein is used as a feed supplement or teed formula for dairy cattle, particularly starter, growing heifers, bulls and dairy beef, lactating dairy cattle and/or non-lactating dairy cattle. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a maximum percentage of equivalent crude protein from non-protein nitrogen of about 6%, in some aspects about 5%, and in some aspects about 4%; a minimum percentage of crude fat in an amount of about 0.25%, in some aspects about 0.5%, in some aspects about 1%, in some aspects about 2%, in some aspects about 3%, in sonic aspects about 4%, and in some aspects about 5%; a maximum percentage of crude fiber in an amount of about 7%, in some aspects about 6%, and in some aspects about 5%; a maximum percentage of acid detergent fiber in an amount of about 16.5%, in some aspects about 15.5%, in some aspects about 14.5%, in some aspects about 13.5%, in sonic aspects about 12.5%, and still in some other aspects about 11.5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; a minimum percentage of phosphorous in an amount of about 0.7%, in some aspects about 0.75%, and in some other aspects about 0.8%; and a minimum selenium in an amount below detection limits of about 2.25 ppm.

In some aspects, the distillers meal as described herein is used as a feed supplement or feed formula for equine, including foal, mare, breeding and/or maintenance equine. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; a minimum percentage of phosphorous in an amount of about 0.7%, in some aspects about 0.75%, and in some other aspects about 0.8%; a minimum amount of copper of about 3 ppm, in some aspects about 4 ppm, in some aspects about 5 ppm, in some aspects about 6 ppm; a minimum selenium in an amount below detection limits of about 2.25 ppm; and a minimum zinc of about 50 ppm, in some aspects about 55 ppm, in some aspects about 60 ppm, in some aspects about 65 ppm, in some aspects about 70 ppm, and in some other aspects about 75 ppm.

In some aspects, the distillers meal as described herein is used as a feed supplement or feed formula for swine, including pre-starter, starter, grower, finisher, gilts, sows and adult boars, lactacting gilts and/or lactating sows. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a minimum percentage of lysine in an amount of about 0.7%, in some aspects about 0.75%, in some aspects about 0.8%, in some aspects about 0.85%, in some aspects about 0.9%, in some aspects about 0.95%, and in some other aspects about 1.0%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; a minimum percentage of phosphorous in an amount of about 0.7%, in some aspects about 0.75%, and in some other aspects about 0.8%; a minimum selenium in an amount below detection limits of about 2.25 ppm; and a minimum zinc of about 50 ppm, in some aspects about 55 ppm, in some aspects about 60 ppm, in some aspects about 65 ppm, in some aspects about 70 ppm, and in some other aspects about 75 ppm.

In some aspects, the distillers meal as described herein is used as a feed supplement or feed formula for poultry, including layer chickens starting/growing, finisher, laying and/or breeder), broiler chickens (starting/growing, finisher and/or breeder), broiler breeder chickens (starting/growing, finishing and/or laying) and/or turkeys (starting/growing, finisher, laying and/or breeder). The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a minimum percentage of lysine in an amount of about 0.7%, in some aspects about 0.75%, in some aspects about 0.8%, in some aspects about 0.85%, in sonic aspects about 0.9%, in some aspects about 0.95%, and in some other aspects about 1.0%; a minimum percentage of methionine of about 0.50%, in some aspects about 0.55%, in some aspects about 0.60%, in some other aspects about 0.65%, and in some other aspects about 0.7%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; and a minimum percentage of phosphorous in an amount of about 0.7%, in some aspects about 0.75%, and in sonic other aspects about 0.8%.

In some aspects, the distillers meal as described herein is used as a feed supplement or feed formula for a goat, including starter, grower, finisher, breeder and/or lactating goats. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a maximum percentage of equivalent crude protein from non-protein nitrogen of about 6%, in some aspects about 5%, and in some aspects about 4%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; a minimum percentage of phosphorous in an amount of about 0.7%, in some aspects about 0.75%, and in some other aspects about 0.8%; a minimum amount of copper of about 3 ppm, in some aspects about 4 ppm, in some aspects about 5 ppm, in some aspects about 6 ppm, and a maximum amount of copper of about 10 ppm, in some aspects about 9 ppm, in some aspects about 8 ppm, in some aspects about 7 ppm, and in some other aspects about 6 ppm; and a minimum selenium in an amount below detection limits of about 2.25 ppm.

In some aspects, the distillers meal as described herein is used as a feed supplement or feed formula for sheep, including starter, grower, finisher, breeder and/or lactating sheep. The distillers meal may have a minimum percentage of crude protein in an amount of about 28%, in some aspects about 29%, in some aspects about 30%, in some aspects about 31%, in so aspects about 32%, in some aspects about 33%, in some aspects about 34%, and in some aspects about 35%; a maximum percentage of equivalent crude protein from non-protein nitrogen of about 6%, in some aspects about 5%, and in some aspects about 4%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; a minimum percentage of phosphorous in an amount of about 0.7%, in some aspects about 0.75%, and in some other aspects about 0.8%; a minimum amount of copper of about 3 ppm, in some aspects about 4 ppm, in some aspects about 5 ppm, in some aspects about 6 ppm, and a maximum amount of copper of about 10 ppm, in some aspects about 9 ppm, in some aspects about 8 ppm, in some aspects about 7 ppm, and in some other aspects about 6 ppm; and a minimum selenium in an amount below detection limits of about 2.25 ppm

In some aspects, the distillers meal as described herein is used as a feed supplement or feed formula for ducks and/or geese, including starter, grower, finisher, breeder developer and/or breeder. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in some aspects about 35%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; and a minimum percentage of phosphorous in an amount of about 0.7%, in some aspects about 0.75%, and in some other aspects about 0.8%.

In some aspects, the distillers meal as described herein is used as a feed supplement or feed formula for fish, including trout, catfish and other species other than trout or catfish. The distillers meal may have a minimum percentage of crude protein in an amount of about 28%, in some aspects about 29%, in some aspects about 30%, in sonic aspects about 31%, in some aspects about 32%, in some aspects about 33%, in some aspects about 34%, and in some aspects about 35%; a minimum percentage of crude fat in an amount of about 0.25%, in some aspects about 0.5%, in some aspects about 1%, in sonic aspects about 2%, in some aspects about 3%, in some aspects about 4%, and in some aspects about 5%; a maximum percentage of crude fiber in an amount of about 7%, in some aspects about 6%, and in some aspects about 5%; and a minimum percentage of phosphorous in an amount of about 0.7%, in some aspects about 0.75%, and in sonic other aspects about 0.8%.

In some aspects, the distillers meal as described herein is used as a feed supplement or feed formula for rabbit, including grower and/or breeder. The distillers meal may have a minimum percentage of crude protein in an amount of about 28%, in some aspects about 29%, in some aspects about 30%, in some aspects about 31%, in some aspects about 32%, in some aspects about 33%, in some aspects about 34%, and in sonic aspects about 35%; a minimum percentage of crude fat in an amount of about 0.25%, in some aspects about 0.5%, in some aspects about 1%, in some aspects about 2%, in some aspects about 3%, in some aspects about 4%, and in some aspects about 5%; a minimum percentage of crude fiber in an amount of about 7%, in sonic aspects about 6%, and in some aspects about 5%; a maximum percentage of crude fiber in an amount of about 7%, in some aspects about 6%, and in some aspects about 5%; a minimum percentage of calcium in an amount of about 0.06%, in some aspects about 0.07%, and in some aspects about 0.08%, and a maximum percentage of calcium in an amount of about 0.2%, in some aspects about 0.1%, in some aspects about 0.15%, in some aspects about 0.095%, and in some other aspects about 0.09%; and a minimum percentage of phosphorous in an amount of about 0.7%, in some aspects about 0.75%, and in some other aspects about 0.8%.

### EXAMPLES

### Example 1

DDGS co-products of the present invention, which had undergone solvent extraction processing of the present invention, were fed to 2000 lactating Holstein dairy cows for a period of 30 days at inclusion rates of 3.5, 5.5 and 7.5 pounds per head of cattle per day. The DDGS co-products of the present invention replaced canola meal as an animal feed product, with the Holstein dairy cows previously on the canola meal supplement used for comparison purposes.

TABLE 1
Comparison of DDGS co-product animal feed supplement to canola meal.

| | Pre-Trial | 30-Day Trial | Difference |
|---|---|---|---|
| Primary Protein Component | Canola Meal | DDGS co-product | — |
| Price Per Ton ($/ton) | 432 | 330 | −102 |
| Milk Production (lbs/day) | 65.38 | 67.77 | +2.39 |
| Butterfat (%) | 3.63 | 3.67 | +0.04 |
| Protein (%) | 3.41 | 3.40 | −0.01 |
| Lactose (%) | 5.02 | 5.01 | −0.01 |
| Solids - Nonfat (%) | 8.99 | 9.02 | +0.03 |
| Average Air Temperature | 74 | 77 | +3.00 |
| (° F.) | | | |
| High Temperature (° F.) | 100 | 108 | +8.00 |

As provided in Table 1, the Holstein dairy cows fed the DDGS co-products of the present invention had an improved milk product yield and quality compared to Holstein dairy cows fed the canola meal supplement.

TABLE 2
Comparison of protein absorption.
Dairy Blood Urea Nitrogen (BUN) Test Results

| Cow #: | Test 1 (Day 0) | Test 2 (Day 30) | Difference | % Change |
|---|---|---|---|---|
| 1 | 7 | 13 | 6 | 86% |
| 2 | 7 | 12 | 5 | 71% |
| 3 | 6 | 9 | 3 | 50% |
| 4 | 7 | 11 | 4 | 57% |
| 5 | 7 | 13 | 6 | 86% |
| 6 | 6 | 7 | 1 | 17% |
| 7 | 5 | 12 | 7 | 140% |
| 8 | 10 | 14 | 4 | 40% |
| 9 | 8 | 13 | 5 | 63% |
| 10 | 7 | 12 | 5 | 71% |
| 11 | 12 | 14 | 2 | 17% |

As provide in Table 2, the blood urea nitrogen levels of eleven Holstein dairy cows were tested while being fed canola meal and before being fed the DDGS co-products of the present invention and also at the conclusion of the 30-day trial. The DDGS co-products of the present invention resulted in significantly increased protein absorption, with the BUN measuring the level of excess dietary protein being fed.

It should be emphasized that the described embodiments of this disclosure are merely possible examples of implementations and are set forth for a clear understanding of the principles of this disclosure. Many variations and modifications may be made to the described embodiments of this disclosure without departing substantially from the spirit and principles of this disclosure. All such modifications and variations are intended to be included herein within the scope of this disclosure and protected by the following claims.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. An animal teed comprising:
distillers meal in an amount ranging from about 5% to about 50% by weight of the total feed on a dry matter basis, the distillers meal having an oil content of about 0.25% to about 7%, and the distillers meal having undergone a denaturing process to provide an increased rumen undegradable protein level that is about 5% to about 25% more than a rumen undegradable protein level of the distillers meal prior to the denaturing process.

2. The animal feed of claim 1, wherein the distillers meal is corn distillers meal.

3. The animal feed of claim 2, wherein the corn distillers meal comprises about 28% to about 35% by weight crude protein, about 25% to about 35% by weight neutral detergent fiber content, and about 11.5% to about 16.5% by weight acid detergent fiber.

4. The animal feed of claim 3, wherein the corn distillers meal comprises about 4% to about 6% total nitrogen.

5. The animal feed of claim 3, wherein the corn distillers meal comprises about 4% to about 6% ash.

6. The animal feed of claim 3, wherein the corn distillers meal comprises about 50% to about 55% nitrogen free extract.

7. The animal feed of claim 3, wherein the corn distillers meal comprises about 75% to about 80% total digestible nutrients.

8. The animal feed of claim 3, wherein the corn distillers meal further comprises comprising nutritional characteristics selected from the group consisting of about 0.70 Mcal/lb to about 0.85 Mcal/lb net energy lactation, about 0.85 Mcal/lb to about 0.89 Mcal/lb net energy maintenance, about 1200 kcal/lb to about 1250 kcal/lb of metabolizable energy, about 0.55 Mcal/lb to about 0.60 Mcal/lb of net energy gain, or any combinations thereof.

9. The animal feed of claim 1, wherein the distillers meal comprises a plurality of particles having a particles size less than about 1 millimeter.

10. The animal feed of claim 1, wherein between about 90% and about 99% of the particles have a particle size between about 150 microns and about 1 millimeter.

11. The animal feed of claim 1, wherein the distillers meal comprises a lysine to residual fat ratio between about 20 to about 200.

12. The animal feed of claim 1 used in feed an animal selected from dairy cattle, beef cattle, equine, swine, poultry, goat, sheep, ducks, geese, fish and rabbit.

13. A method of manufacturing a distillers meal having an increased level of rumen undegradable protein, the method comprising:
extracting oil from an input distillers dried grains with solubles (DDGS) byproduct using a solvent to produce a de-oiled DDGS byproduct;
desolventizing the de-oiled DDGS byproduct to produce a desolventized DDGS byproduct;
adding moisture to the desolventized DDGS byproduct to produce a moistened DDGS byproduct;
heating the moistened DDGS byproduct to produce a toasted DDGS byproduct;
drying the toasted DDGS byproduct to produce a dried DDGS byproduct; and
cooling the dried DDGS byproduct to produce the distillers meal;
wherein the distillers meal has an increased level of rumen undegradable protein in an amount of about 5% to about 25% compared to the input DDGS byproduct.

14. The method of claim 13, wherein the distillers meal comprises about 28% to about 35% by weight crude protein, about 0.25% to about 7% oil content, about 25% to about 35% by weight neutral detergent fiber content, and about 11.5% to about 16.5% by weight acid detergent fiber.

15. The method of claim 14, wherein the distillers meal comprises about 4% to about 6% total nitrogen, about 4% to about 6% ash, about 50% to about 55% nitrogen free extract, and about 75% to about 80% total digestible nutrients.

16. The method of claim 14, wherein the distillers meal further comprises comprising nutritional characteristics selected from the group consisting of about 0.70 Mcal/lb to about 0.85 Mcal/lb net energy lactation, about 0.85 Mcal/lb to about 0.89 Mcal/lb net energy maintenance, about 1200 kcal/lb to about 1250 kcal/lb of metabolizable energy, about 0.55 Mcal/lb to about 0.60 Mcal/lb of net energy gain, or any combinations thereof.

17. The method of claim 13, further comprising grinding the distillers meal such that about 90% to about 99% of the particles have a particle size between about 150 microns and about 1 millimeter.

18. The method of claim 13, wherein moisture is added to the desolventized DDGS byproduct by steam injection or water injection with water or a solvent containing water.

19. The method of claim 13, wherein the moistened DDGS undergoes the heating and drying steps by applying airflow at a temperature between about 200° F. and about 325° F.

20. The method of claim 19, wherein the airflow is applied for a period of time between about 30 minutes to about 90 minutes at a flow rate between about 15 CFM/T to about 75 CFM/T.

21. The method of claim 13, wherein the solvent is a non-polar solvent having a boiling point in the range of about 36° C. to about 99° C.

22. The method of claim 13, wherein the solvent s commercial grade hexane.

23. The method of claim 13, wherein the solvent is a mixture of a polar solvent and a non-polar solvent that forms an azeotrope.

24. A method increasing a level of rumen undegradable protein in distillers meal, the method comprising:
extracting oil from an input distillers dried grains with solubles (DDGS) byproduct using a solvent comprising hexane to produce a de-oiled DDGS byproduct having about 0.25% to about 7% oil content;
desolventizing the de-oiled DDGS byproduct to produce a desolventized DDGS byproduct;
adding moisture to the desolventized DDGS byproduct to produce a moistened DDGS byproduct;
heating and drying the moistened DDGS byproduct at a temperature between about 200° F. to about 325° F. for a period of time between about 30 minutes to about 90 minutes to produce a toasted DDGS byproduct; and
cooling the dried DDGS byproduct to produce the distillers meal;
wherein the distillers meal has an increased level of rumen undegradable protein in an amount of about 5% to about 25% compared to the input DDGS byproduct.
